(19) United States
(12) Patent Application Publication
(10) Pub. No.: US 2019/0052979 A1
(43) Pub. Date: Feb. 14, 2019

(54) SYSTEMS AND METHODS FOR WIRELESSLY CHARGING A HEARING DEVICE

(71) Applicants: OHIO STATE INNOVATION FOUNDATION, Columbus, OH (US); NIKOLA LABS, Westerville, OH (US)

(72) Inventors: Chi-Chih CHEN, Dublin, OH (US); Roland Kyle TALLOS, Polk, OH (US)

(21) Appl. No.: 16/078,309

(22) PCT Filed: Jan. 5, 2018
(86) PCT No.: PCT/US2018/012527

§ 371 Date: Aug. 21, 2018

Related U.S. Application Data
(60) Provisional application No. 62/442,966, filed on Jan. 5, 2017.

(51) Int. Cl. H04R 25/00; H02J 7/02; H02J 50/23

(52) U.S. Cl. CPC H04R 25/554; H02J 7/025; H02J 7/345; H04R 25/602; H02J 50/23

(57) ABSTRACT

Systems and methods are described herein for wirelessly charging a hearing device while the hearing device is being worn by a user. The hearing device can be configured to receive radio-frequency (RF) energy. The hearing device can include a power storage element. The RF energy can be converted to electrical energy, and stored at the power storage element while the hearing device is being worn by the user.

### CROSS-REFERENCE TO RELATED APPLICATION

This application claims the benefit of U.S. Provisional Patent Application No. 62/442,966, filed Jan. 5, 2017, and entitled “WIRELESSLY POWER DELIVERY FOR HEARING AID INTRODUCTION,” the entire contents of which is incorporated herein by reference.

### TECHNICAL FIELD

This disclosure generally relates to systems and methods for wirelessly charging a hearing device.

### BACKGROUND

Hearing devices are commonly used to compensate for hearing impairments. A hearing device is typically configured with a battery. The operating life of the hearing device is a function of an amount of electrical energy stored at the battery, and a demand on the hearing device. Existing in-the-canal (ITC), completely-in-canal (CIC), and invisible-in-the-canal (IIC) hear devices have no option of replacing or recharging the battery. Thus, users of these types of hearing devices are required to replace the entire device when the battery has depleted. In contrast to ear-canal driven hearing devices, existing in-the-ear (ITE) and behind-the-ear (BTE) hearing devices permit the user to replace the battery or recharge the battery. Thus, the user can continue to employ the hearing device by replacing the depleted battery with a new battery, or recharging the battery. In a particular application, the user can wirelessly charge the hearing device by placing the device in charging range of a wireless charging station.

### SUMMARY

In an example, a method for wirelessly charging a hearing device can include receiving at a hearing device radio-frequency (RF) energy, the hearing device including a power storage element, converting the RF energy to electrical energy, and storing the electrical energy at the storage element of the hearing device while the hearing device is being worn by a user.

In another example, a system can include a hearing device that can include an antenna that can be configured to receive RF energy while the hearing device is being worn by a user, an RF harvester that can be configured to convert the RF energy to electrical energy and a power storage element that can be configured to receive and store the electrical energy.

In an even further example, a method for wirelessly charging a hearing device can include configuring an antenna of an RF emitting device to emit RF energy, receiving at an antenna of the hearing device the RF energy while the hearing device is being worn by a user, converting the RF energy to electrical energy and providing the electrical energy to a storage element of the hearing device corresponding to storing charge at the storage element of the hearing device.

The summary is provided merely for purposes of summarizing some example embodiments so as to provide a basic understanding of some aspects of the disclosure. Accordingly, it will be appreciated that the above described examples should not be construed to narrow the scope or spirit of the disclosure in any way. Other examples, embodiments, aspects, and advantages will become apparent from the following detailed description taken in conjunction with the accompanying drawings.

### BRIEF DESCRIPTION OF THE DRAWINGS

FIG. 1 illustrates an exemplary wireless hearing device charging system.

FIG. 2 illustrates an exemplary hearing device,

FIG. 3 illustrates an exemplary in-ear headphone configured with an antenna of a radio-frequency (RF) emitting device as described herein.

FIGS. 4(a)-4(c) illustrates geometrical effects of a helical antenna on a resonant frequency.

FIG. 5 illustrates exemplary simulation data of coupling between helical antennas at a given distance.

FIG. 6 illustrates an example of an exemplary hearing device positioned with an ear model.

FIG. 7 illustrates an example of wireless power delivery to an exemplary hearing device positioned within an ear model.

FIG. 8 depicts an example of a flow diagram illustrating an exemplary method for wirelessly charging a hearing device.

FIG. 9 depicts another example of a flow diagram illustrating an exemplary method for wirelessly charging a hearing device,

### DETAILED DESCRIPTION

Systems and methods are described herein for wirelessly charging a hearing device. According to the systems and methods described herein, the hearing device can be charged while the hearing device is being worn by a user. In some examples, the hearing device can be partially or fully positioned within a user's ear canal. In other examples, the hearing device can be positioned behind a user's ear, at a pinna, or around the user's ear. Thus, the systems and methods described herein permit the hearing device to be charged while the hearing device is being worn by the user. The user is not required to remove the hearing device for battery maintenance (e.g., charging and/or replacing), or dispose of the hearing device in contrast to existing hearing devices.

The systems and methods described herein can be applied to any available hearing device, including, but not limited to, in-the-canal (ITC), completely-in-canal (CIC), and invisible-in-the-canal (IIC) hear devices, in-the-ear (ITE), and behind-the-ear (BTE) devices. Existing hearing devices can be configured with radio-frequency (RF) harvesting technology described herein such that the hearing devices can harvest RF energy. The hearing device can convert the harvested RF energy to electrical energy and store the electrical energy at a power storage element. The stored electrical energy can be used by the hearing device to charge one or more elements of the hearing device, and/or enable the one or more elements to perform one or more functions. Accordingly, the systems and methods permit hearing devices to be wirelessly charged while being worn by the user.

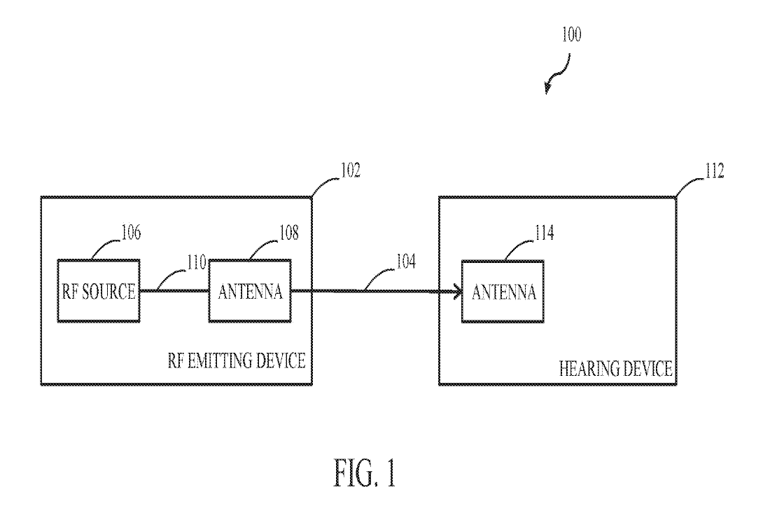

FIG. 1 illustrates an exemplary wireless hearing device charging system 100 (or system 100). The system 100 can include a radio-frequency (RF) emitting device 102. The RF emitting device 102 can be configured to generate one or more RF signals 104 (or RF energy 104). In some examples, the one or more RF signals 104 in a band near 900 Megahertz (MHz) can be used, while in other examples, the WMS 104 can be configured to harvesting energy from one or more RF signals 104 in other frequency bands, including, but not limited to, very high frequency (VHF) and ultra-high frequency (UHF) bands, or other bands such as 10 MHz-88 MHz, 88 MHz-108 MHz, 108 MHz-500 MHz, 500 MHz-900 MHz, 900 MHz-1 Gigahertz (GHz), 1 GHz-2.4 GHz, 2.4 GHz-2.5 GHz, 2.5 GHz-5 GHz, and 5 GHz-6 GHz. In an example, the RF emitting device 102 can be configured to generate RF energy having a frequency at 2.45 GHz, or within a given percentage of this frequency (e.g., within 5%).

In some examples, the RF emitting device 102 can include an RF source 106. The RF source 106 can be configured to generate the one or more RF signals 104. The RF emitting device 102 can include an antenna 108. The antenna 108 can be configured to emit the one or more RF signals 104. The antenna 108 can be coupled to the RF source 106 via RF cables 110. In some examples, the RF emitting device 102 can be housed within a headphone (not shown in FIG. 1). In other examples, only the antenna 108 can be housed in the headphone. In either of these examples, the RF emitting device 102 or the antenna 108 can be housed within the headphone such that normal audio operations of the headphone are not affected. Conventional portable devices, such as cellular devices, media player devices, or the like, often can include a pair of headphones. The headphones can be connected to the portable device. In some instances, the headphones can be wirelessly connected to the portable device, in others, the headphones can be connected with one or more wires to the portable device.

In general, headphones vary in style, shape, and size. Types of headphones can include, but are not limited to, around-ear headphones, full-size headphones, on-ear headphones, earphones (or earbuds), and in-ear headphones (or also known as in-ear monitors (IEMs). Around-ear headphones are commonly configured with cups or pads that can fit over or on the user's ears and are secured together and against the ears or head of the user by a resiliently-deformable band. On-ear headphones are similar in design to around-ear phones, though the cups or pads sit on an outer ear rather than enclosing the ears. Earphones are commonly configured to fit directly in a user's outer ear, facing but not inserted in the user's ear canal. In-ear headphones are configured with similar portability to earphones, but are designed for insertion in the user's ear canal itself,

The examples described herein relate to in-ear headphones. However, the examples described herein should not be construed and/or limited to only these type of headphones. The examples described herein are equally as applicable to around-ear headphones, full-size headphones, on-ear headphones, and earphones. Thus, the antenna 108 can be configured with any type of headphone style. The antenna 108 can have a small enough form factor that can permit the antenna 108 to be placed within the structural limitations of the headphone. In other examples, the RF emitting device 102 can have a form factor that can permit the device 102 to be placed within the structural configurations of the headphone.

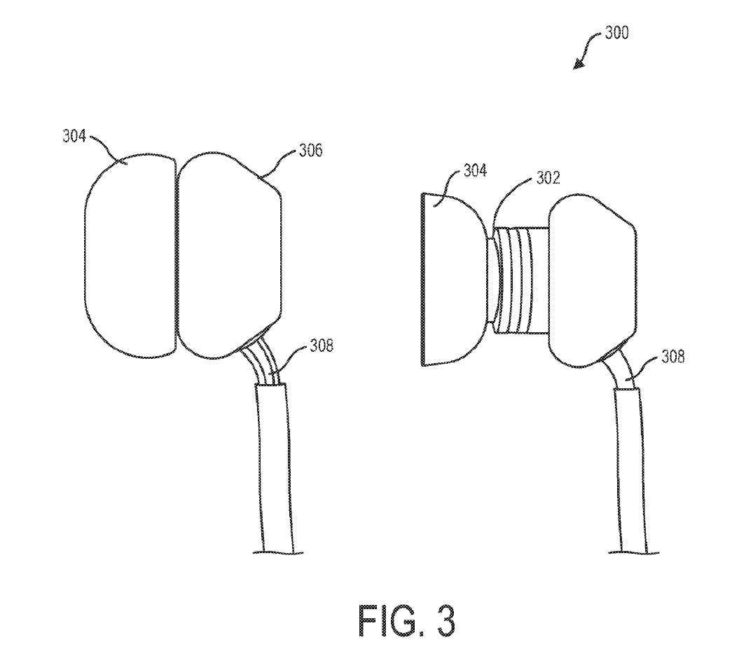

In some examples, the antenna 108 can be configured relative to an in-ear headphone. FIG. 3 illustrates an example of an in-ear headphone 300 configured with an antenna 302. The antenna 302 can correspond to the antenna 108, as illustrated in FIG. 1. In an example, the antenna 302 can be placed underneath a cushion 304 of the in-ear headphone 300. In another example, the antenna 302 can be positioned within a housing 306 of the antenna 302 (not shown in FIG. 3). The antenna 302 can be coupled to an RF source (not shown in FIG. 3) via an RF cable(s) 308. The RF source can correspond to the RF source 106, as illustrated in FIG. 1. In some examples, the RF source can be configured to generate one or more RF signals, such as the one or more RF signals 104, as illustrated in FIG. 1. Additionally, or alternatively, the RF source can correspond to a 2.45 GHz source. In some examples, the antenna 302 can have a helical shape.

The system 100 of FIG. 1 can include a hearing device 112. The hearing device 112 device can be worn by the user to enhance the user's hearing capabilities. In some examples, the hearing device 112 can be positioned (or placed) partially or fully within a user's ear canal. Thus, the hearing device 112 can have a form factor that can permits the device to be fully or partially placed in an ear canal of the user. In other examples, the hearing device 112 can be positioned behind a user's ear, at a pinna, or around the user's ear.

In some examples, the antenna 108 of the RF emitting device 102 can be oriented in the housing of the headphone such that the antenna 108 faces a similar direction as a speaker of the headphone. The user can position the headphone relative to the user's ear as a normal headphone. The hearing device 112 can include an antenna 114. The antenna 114 can be configured to receive (or capture) the one or more RF signals 104 emitted by the antenna 108 of the RF emitting device 102 while the hearing device 112 is being worn by the user. It should be understood that the antennas 108,114 described herein can include many types of antenna designs. Thus, although the examples described herein illustrate helical antennas, the examples should not be construed and/or limited to only these type of antennas. The type of antennas that the systems and methods described herein are applicable to can include, but not limited to, monopole, dipole, loop, patch, inverted-F, etc.

In some examples, the antenna 108 of the RF emitting device 102 can be of one type, while the antenna 114 of the hearing device 112 can be of another type. For example, the antenna 108 of the RF emitting device 102 can be a helical antenna, while the antenna 114 of the hearing device 112 can be a different antenna type. In other examples, the antennas 108,114 can be of similar types. For example, the antennas 108,114 can be helical antennas. The antennas 108,114 described herein can be tuned to resonate at a desired operating frequency. A resonance frequency of a given antenna can be a function of one of an antenna's loop diameter, wire pitch, a number of turns, wire thickness, and a combination thereof.

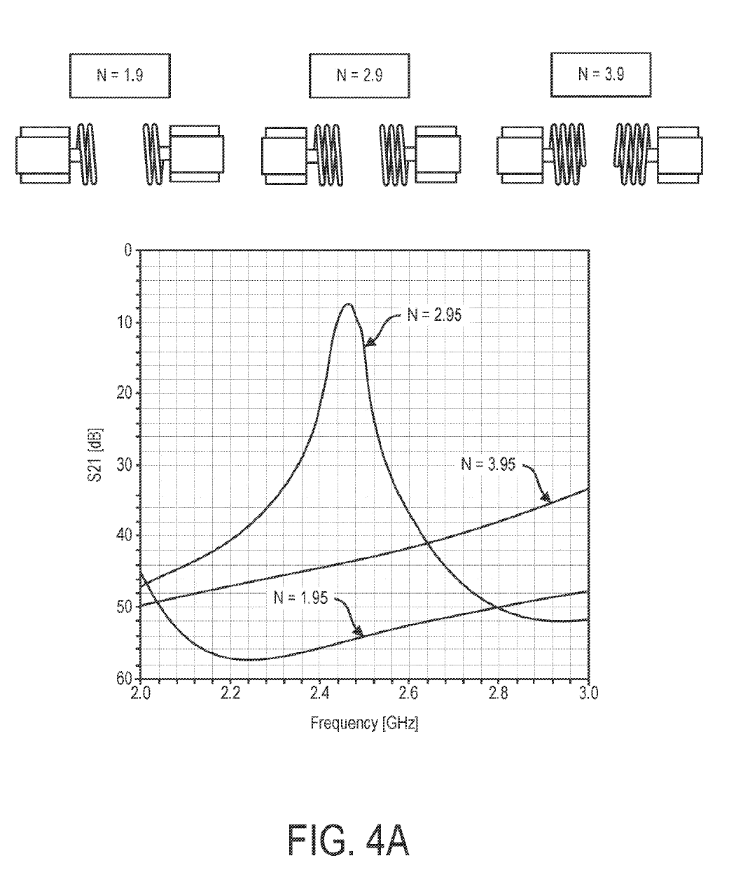

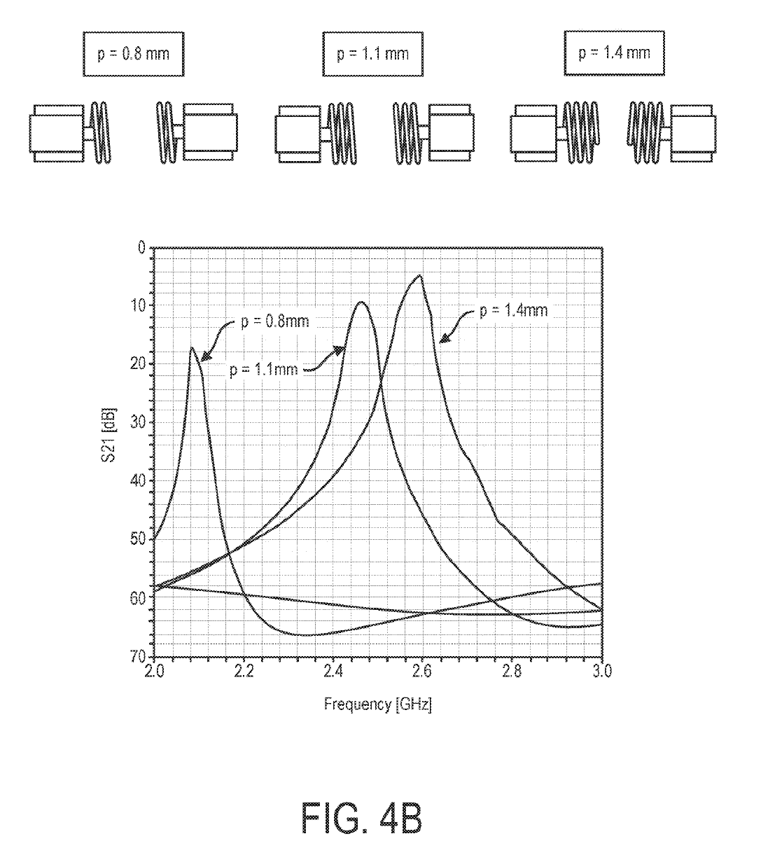

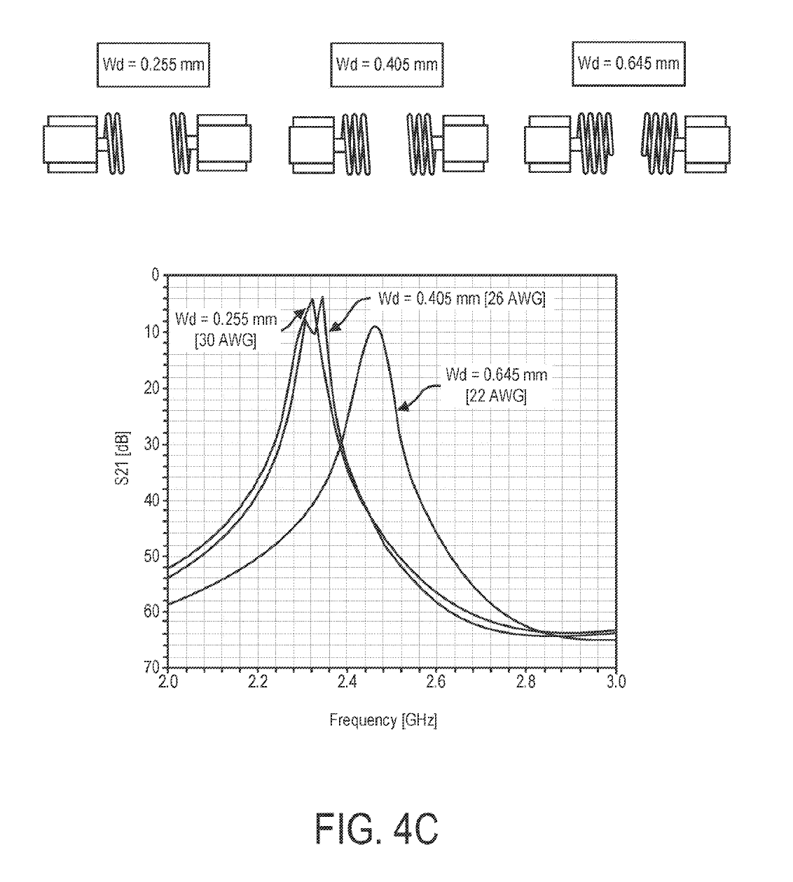

For example, the resonance frequency of a helical antenna can be a function of the antenna's loop diameter, the wire pitch, the number of turns, and the wire thickness. FIGS. 4(a)-4(c) illustrate geometrical effects that a helical antenna can have on a resonant frequency. The illustrated values are for explanation purposes, and other values can be used. Geometrical effects can include, but not limited to, a number of wire turns, helix pitch, and wire diameter. FIG. 4(a) illustrates that by increasing the number wire turns, increases the resonant frequency. FIG. 4(b) illustrates that by increasing the helix pitch, the resonant frequency increases, while FIG. 4(c) illustrates that by increasing the wire diameter, increases the resonant frequency. The antennas 108,114 described herein can be integrated into packages, structures, or enclosures. For example, the antenna 108 can be integrated into the headphone, and the antenna 114 can be integrated into the hearing device 112.

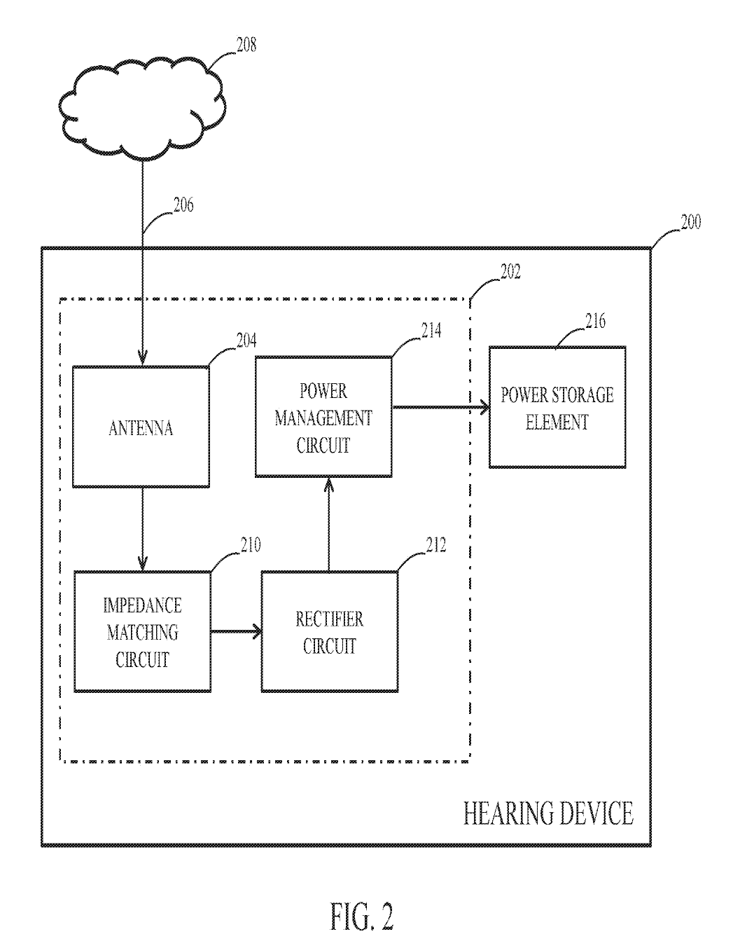

The hearing device 112 can be configured to convert the RF energy 104 into electrical energy. For example, the hearing device 112 can be configured to convert the RF energy 104 into alternating-current (AC) energy. The AC energy can be further converted by the hearing device 112 to the electrical energy. In an example, the hearing device can be configured to convert the AC energy into DC energy. The electrical energy can be used by the hearing device 112 to provide charge to a power storage element, such as a power storage element 216, as illustrated in FIG. 2. In some examples, the power storage element can include one or more batteries, capacitors, and/or other types of power storage elements. By harvesting the RF energy 104, the hearing device 112 does require periodic maintenance, such as existing hearing devices. Existing hearing devices require removal of the hearing device and either removal of the battery for recharging, or placement of the hearing device near a wireless charging station. Accordingly, the hearing device 112 has particular advantages over existing hearing devices. The electrical energy stored at the power storage element can be used by the hearing device 112 to power one or of its internal elements, and/or perform one or more functions (e.g., operations related to hearing aid functions).

The hearing device 112 can be configured to harvest the RF energy 104 until a given amount of electrical energy has been stored at the power storage element. The hearing device 112 can be configured to periodically (or continuously) determine an amount of direct current (DC) voltage stored at the power storage element. The hearing device 112 can be configured to compare the amount of DC voltage at the power storage element to a DC voltage threshold. The hearing device 112 can be configured to seize harvesting RF energy based on the result of the comparison indicating that the amount of DC voltage at the power storage element is equal to or within a given percentage (e.g., 5%) of the DC voltage threshold. In some examples, the hearing device 112 can be configured to harvest the RF energy 104 while the user is listening to audio (e.g., music) generated by an associated portable device.

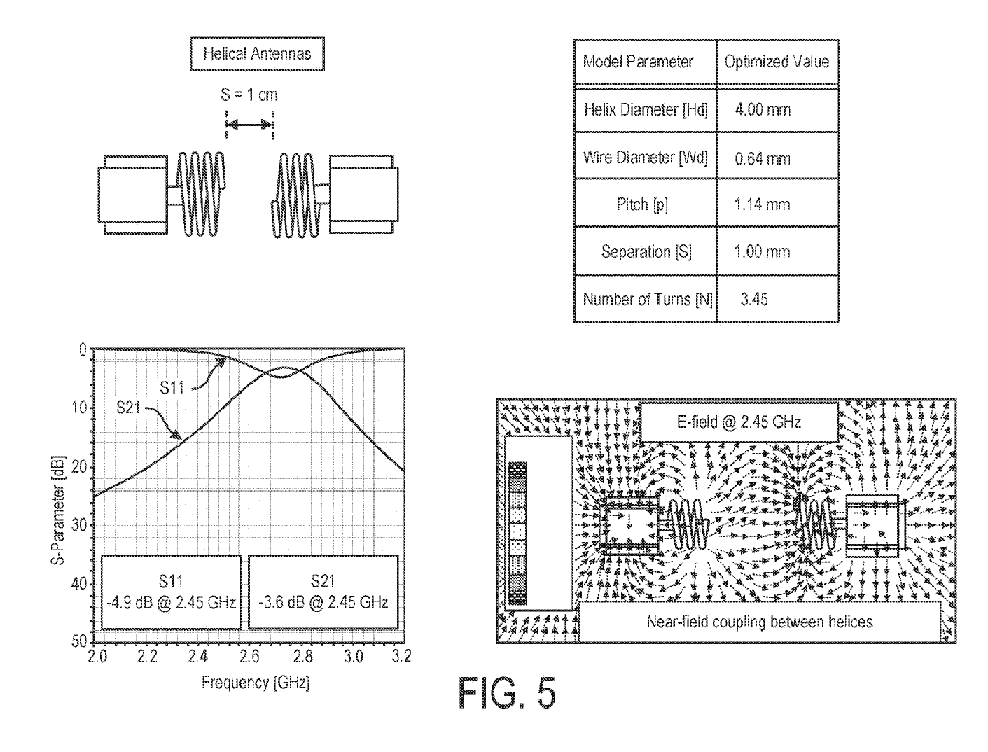

Accordingly, the hearing device 112 described herein can be configured to receive wireless power from an RF energy source, such as the RF emitting device 102. In some examples, the RF emitting device 102 and the hearing device 112 can be configured with a helical antenna. This configuration can maximize an amount of power delivered to the hearing device 112. Furthermore, a major advantage of employing helical antenna's at both the RF emitting device 102 and the hearing device 112, is that an antenna's performance does not depend on rotation angles. Additionally, the antenna 108,114 can be configured such that a distance between the respective antennas 108,114 is about 1 centimeter (cm). Thus, when the distance between helical antenna's is not greater than an antenna's loop diameter, strong coupling can occur between the respective antennas, such as illustrated in simulation data of FIG. 5.

Additionally, or alternatively, the hearing device 112 of FIG. 1 can have a power consumption in a range of about 100 μW to about 1.3 Bolts (V). In some examples, the hearing device 112 can be a size of a coffee bean. In order to minimize impedance mismatch loss, the antenna 114 of the hearing device 112 can be operated under a resonance condition, which can require the length of half wavelengths for dipole or a circumference of a single wavelength. At 2.4 GHz, it can mean a dipole length of 6.25 centimeters (cm) or loop diameter of 4 cm at 2.4 GHz.

In some examples, the hearing device 112 can be configured with a 1.3 V battery that can hold 75 milli-ampere-hours (mAh) of charge. In these examples, the power storage element described herein can correspond to the 1.3 V battery. Thus, the battery can hold or store a total energy of about 351 Joules (J) according to E(Joule)=(Q(mAh)/1000)×V(volt)×3600(s). Given that 1 J is about the same amount of energy as a supply of 1 Watt (W) for 1 second according to E(joule)=P(watt)×T(sec), it can require a charging time of approximately of about 1 hour at a 100 milliwatt (mW) rate, or 10 hours at a 10 mW rate. If a rechargeable battery such as P10 ACCU Ni-MH 1.2V 12 mAh battery is employed, which can have a dimension of 5.8 mm (D) by 2.5 mm (H), it can permit the hearing device 112 to operate for at least 2 weeks since the battery can last for at least 3 months, or 90 days. The charging time for this 1.2 V 12 m Ah battery at a 10 mW rate can require approximately 1.5 hours (90 minutes). If the charging device 112 is worn around the year, it can deliver power at a rate higher than 10 mW with a 100 mW transmitting power. Therefore, a 20 mW of charging rate which requires 20% of overall power deliver efficiency from a 100 mW charger for 45 minutes can last for 2 weeks. In some examples, the capacitance will need to be greater than 0.94 F@5 V or 2.6 F@3 V since the energy stored in a capacitor C with voltage V is E(joule)=(½)×C×V², if it is desired to store 3-days' worth of electrical energy in a capacitor of the hearing device 112. Additionally, or alternatively, the hearing device 112 can have wire loops for pulling the hearing device 112 out of the user's ear canal. In this example, the wire loops can correspond to the antenna 114 of the hearing device 112. A total length of each wire of the antenna 114 can be approximately 20 millimeters (mm) from an attachment point of the hearing device 112.

FIG. 2 illustrates an exemplary hearing device 200. The hearing device 200 can correspond to the hearing device 112, as illustrated in FIG. 1. The hearing device 200 can include an RF harvester 202. The RF harvester 202 can include an antenna 204. In an example, the antenna 204 can correspond to the antenna 112, as illustrated in FIG. 1. The antenna 204 can be configured to receive RF energy 206 from an RF environment 208. The RF environment 208 can be configured to provide the RF energy 206. In some examples, the RF environment 208 can include an RF emitting device (not shown in FIG. 2), which can be configured to generate the RF energy 206. For example, the RF emitting device can correspond to the RF emitting device 102, as illustrated in FIG. 1. The RF energy 206 received at the antenna 204 can induce alternating-current (AC) energy in the antenna 204.

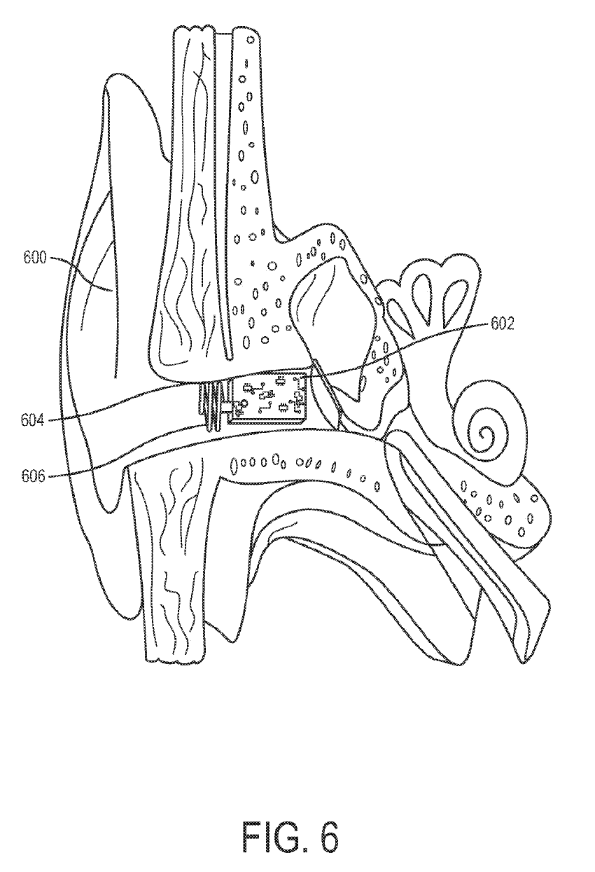

In some examples, the hearing device 200 can be positioned behind a user's ear, at a pinna, or around the users ear. In other examples, the hearing device 200 can be positioned partially or fully within a user's ear canal. FIG. 6 illustrates an example of a hearing device 602 positioned within an ear model 600. The hearing device 602 can correspond to the hearing device 200, as illustrated in FIG. 2. The hearing device 602 can be positioned within an ear canal 604 of the ear model 600. The ear model 600 can be representative of a human ear. The hearing device 600 can include an antenna 606. In some examples, such as illustrated in FIG. 6, the antenna 606 can have a helical design.

The RF harvester 202 can include an impedance matching circuit 210. The impedance matching circuit 210 can improve an efficiency of power transfer from the antenna 204 to a rectifier circuit 212. The impedance matching circuit 210 can be used to maximize a power transfer to the rectifier circuit 212 and minimize signal reflection. By providing the impedance matching circuit 210, an impedance of the antenna 204 can be set to match an impedance of the rectifier circuit 210. When the hearing device 200 is in use, the antenna 204 can be placed near the human body, such as partially or fully within the ear canal. As a result, an impedance of the antenna 204 can change, which can cause an impedance mismatch with the rectifier circuit 212. A change in antenna characteristics can be commensurate with a reduction in the antennas efficiency (e.g., by a change in reflection coefficient or gain deterioration). By configuring the hearing device 200 with the impedance matching circuit 210, impedance mismatches caused by the human body can be suppressed and/or mitigated.

The impedance matching circuit 210 can be configured to receive the AC voltage induced at the antenna 204 and deliver the AC voltage to the rectifier circuit 212. Although not shown in FIG. 2, the rectifier circuit 212 can include a diode(s), a transistor(s), or some other rectifying device or a combination. Examples of the rectifier circuit 212 can include, but are not limited to, a half-wave circuit, a full-wave circuit, and a voltage doubling circuit. The rectifier circuit 212 can be configured to generate a direct-current (DC) voltage based on the AC voltage.

The RF harvester 202 can include a power management circuit 214. The power management circuit 214 can be used to regulate the converted power (e.g., hold the outputted DC voltage at a constant level). The power management circuit 214 can be configured to regulate the outputted DC voltage of the rectifier circuit 212 such that the voltage maintains a constant amplitude. The power regulation functionality can be implemented in many different ways. In some examples, the power regulation circuit can include one of a Zener diode, an integrated circuit such as a linear voltage regulator, a switching regulator, and a combination thereof. In some examples, the power management circuit 214 can include an RF choke. The RF choke can be configured to block unconverted AC voltage, while passing the DC voltage generated by the rectifier circuit 212.

The power management circuit 214 can be used to regulate the DC voltage and ensure that the DC voltage is compatible with charging requirements of the hearing device 200. Additionally, or alternatively, the power management circuit 214 can include a DC-to-DC converter. The DC-to-DC converter can be configured to step and/or step-down the DC voltage according to charging requirements of the hearing device 200. In some examples, the power management circuit 214 can include a control circuit that can be configured to maintain an outputted DC voltage at the DC-to-DC converter at a steady-state,

The power management circuit 214 can be configured to control an amount of electrical energy stored at a power storage element 216 of the hearing device 200. The power storage element 216 can include one or more capacitors, a battery, and/or other types of power storage elements 216. In some examples, the one or more capacitors be low-loss or low resistance type. The power management circuit 214 can be configured to provide the outputted DC voltage to the power storage element 216 corresponding to providing electrical charge to the power storage element 216. The hearing device 200 can be configured to harvest the RF energy 206 until a given amount of electrical energy has been stored at the power storage element 216. For example, the power management circuit 214 can be configured to periodically (or continuously) determine an amount of DC voltage stored at the power storage element 216. The power management circuit 214 can be configured to compare the amount of DC voltage at the power storage element 216 to a DC voltage threshold. The power management circuit 214 can control the rectifier circuit 212 to seize converting energy based on the result of the comparison indicating that the amount of DC voltage at the power storage element 216 is equal to or within a given percentage (e.g., 5%) of the DC voltage threshold.

In some examples, the power management circuit 214 (or another element of the hearing device 200) can be configured to generate an alert signal based on the result of the comparison. For example, if the result of the comparison indicates that the amount of DC voltage at the power storage element 216 is equal to or within the given percentage of the DC voltage threshold, the power management circuit 214 (or the other element) can be configured to generate the alert signal. In some examples, the alert signal can be provided to a light emitting diode (not shown in FIG. 2). The light emitting diode can be configured to emit a light to alert the user that the hearing device 200 is charged, and that the user can remove the headphone from the ear.

In other examples, the alert signal can be supplied to an interference module (not shown in FIG. 2). The interference module can be configured to generate an interference signal that can interact with audio signals emitted by a speaker of the headphone. The interference can cause a distortion in a quality of soundwaves emitted by the speaker device, which can be an indication to the user that the hearing device 200 is charged. In some examples, the interference module can be configured to communicate wirelessly with one or more other devices, e.g., when the hearing device 200 has been removed from the user's ear canal to alert the user that the hearing device 200 is charged. In even further examples, the hearing device 200 can include an audio device (not shown FIG. 2). The audio device can include a speaker. The audio device can be configured to generate one more audible alerts based on the alert signal. The audible alerts can include one or more sound(s) that may be detectable by the user of the hearing device. In an example, the one or more sounds are one or more beeps.

Although not illustrated in FIG. 2, the hearing device 200 can include one or more additional components that may be needed for normal operation and/or functionality. For example, the hearing device 200 can include, but not limited to, a computer system and memory. The computer system can include one or more processors that can be configured to process data received for application, as well as generate data for communication to one or more components of the hearing device 200 (e.g., the power management circuit 214). Thus, in some examples, the computer system can be configured to generate the alert signal based on the result of the comparison. The memory can be configured to store a type of hearing aid, power requirements (e.g., usage requirements), software, manufacturing information, biometrics, and other types of data. The electrical energy stored at the power storage element 216 can be used to power the one or more additional components and/or perform one or more hearing aid related functions of the hearing device 200.

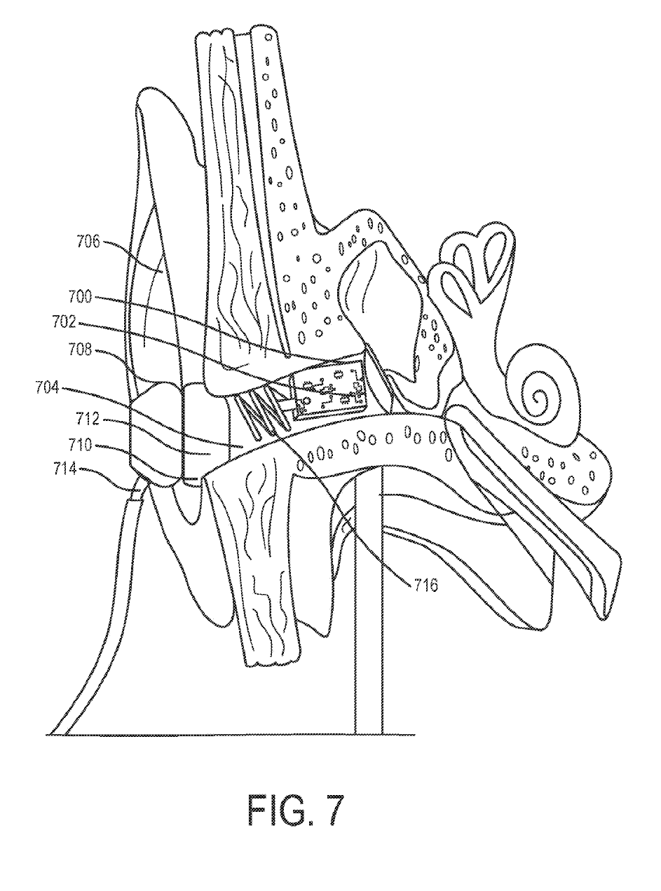

FIG. 7 illustrates an example of wireless power delivery to an exemplary hearing device positioned within an ear model. In FIG. 7, the harvested energy is used to illuminate an LED 700 rather than actuating one or more functions of hearing device 702 to illustrate a concept of wireless charging of a hearing device within an ear canal of a user according to the system and methods described herein. The hearing device 702 can correspond to the hearing device 112, as illustrated in FIG, 1, the hearing device 200, as illustrated in FIG. 2, or the hearing device 602, as illustrated in FIG. 6. As shown in FIG. 7, the hearing device 702 can be fully positioned within an ear canal 704 of a user's ear model 706. In some examples, the human ear model 706 can correspond to the model 600, as illustrated in FIG. 6. As shown in FIG. 7, a headphone 708 of a pair of headphones can be positioned partially or fully within the ear canal 704. The headphone 708 can be configured with an antenna 710. The antenna 710 can correspond to the antenna 108, as illustrated in FIG. 1, or the antenna 302, as illustrated in FIG. 3. In some examples, the antenna 710 can be a helical antenna. In an example, the antenna 710 can be positioned underneath a cushion 712 of the headphone 708.

The antenna 710 can be coupled via RF cables 714 to an RF source (not shown in FIG. 7). In some examples, the RF source can correspond to the RF source 102, as illustrated in FIG. 1. The RF source can be configured to generate RF energy that the RF cable 714 can provide to the antenna 710. The RF energy can correspond to the RF energy 104, as illustrated in FIG. 1, or the RF energy 206, as illustrated in FIG. 1. The antenna 710 can be configured to emit the RF energy. An antenna 716 of the hearing device 702 can be configured to receive the emitted RF energy. The antenna 716 can correspond to the antenna 114, as illustrated in FIG. 1, the antenna 606, as illustrated in FIG. 6, or the antenna 204, as illustrated in FIG, 2. In some examples, as illustrated in FIG, 7, the antenna 716 can be a helical antenna. The hearing device 702 can be configured to convert the RF energy to electrical energy and store the electrical energy at a power storage element of the hearing device (not shown in FIG. 7). The power storage element can correspond to the power storage element 214, as illustrated in FIG. 2. The stored electrical energy can be used to illuminate the LED 700 to illustrate that the hearing device 702 is being wirelessly charged while being worn by the user.

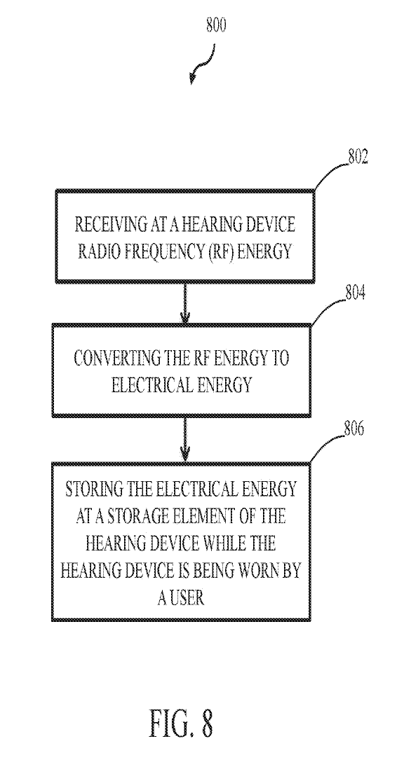

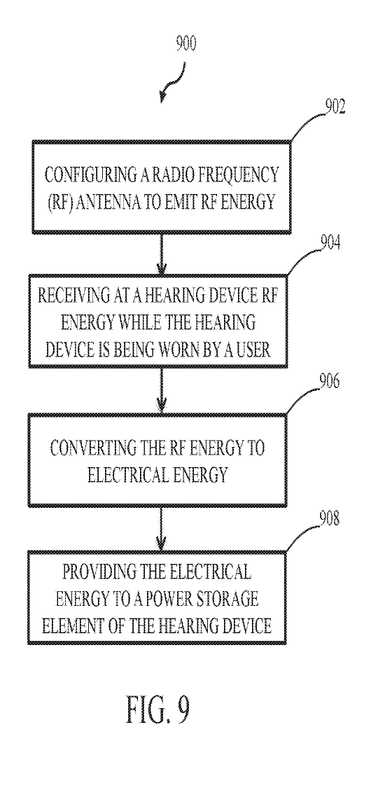

In view of the foregoing structural and functional features described above, methods that can be implemented will be better appreciated with reference to FIGS. 8-9. While, for purposes of simplicity of explanation, the methods of FIGS. 8-9 are shown and described as executing serially, it is to be understood and appreciated that such method is not limited by the illustrated order, as some aspects could, in other embodiments, occur in different orders and/or concurrently with other aspects from that shown and described herein. Moreover, not all illustrated features may be required to implement a method,

FIG. 8 depicts an example of a flow diagram illustrating an exemplary method for wirelessly charging a hearing device. In some examples, the hearing device can correspond to the hearing device 112, as illustrated in FIG. 1, the hearing device 200, as illustrated in FIG. 2, the hearing device 602, as illustrated in FIG. 6, or the hearing device 702, as illustrated in FIG. 7. The method begins at 802 by receiving at a hearing device RF energy. The hearing device can include a power storage element (e.g., the power storage element 216, as illustrated in FIG. 2). At 804, converting the RF energy to electrical energy. At 806, storing the electrical energy at the power storage element while the hearing device is being worn by a user.

FIG. 9 depicts another example of a flow diagram illustrating an exemplary method for wirelessly charging a hearing device. In some examples, the hearing device can correspond to the hearing device 112, as illustrated in FIG. 1, the hearing device 200, as illustrated in FIG. 2, the hearing device 602, as illustrated in FIG. 6, or the hearing device 702, as illustrated in FIG. 7. The method begins at 902 by configuring an antenna of an RF emitting device to emit RF energy. The RF emitting device can correspond to the RF emitting device 102, as illustrated in FIG, 1. At 904, receiving at an antenna of the hearing device the RF energy while the hearing device is being worn by a user. At 906, converting the RF energy to electrical energy. At 908, providing the electrical energy to a power storage element of the hearing device corresponding to storing charge at the storage element of the hearing device. In some examples, the power storage element can correspond to the power storage element 216, as illustrated in FIG. 2.

What have been described above are examples. It is, of course, not possible to describe every conceivable combination of elements, components, or methods, but one of ordinary skill in the art will recognize that many further combinations and permutations are possible. Accordingly, the disclosure is intended to embrace all such alterations, modifications, and variations that fall within the scope of this application, including the appended claims. Additionally, where the disclosure or claims recite “a” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is

1. A method for wirelessly charging a hearing device comprising:
receiving at the hearing device RF energy, the hearing device including a power storage element;
converting the RF energy to electrical energy; and
storing the electrical energy at the storage element of the hearing device while the hearing device is being worn by a user.

2. The method of claim 1, further comprising configuring an antenna of an RF emitting device to emit the RF energy.

3. The method of claim 2, further comprising:
configuring a headphone of a pair of headphones with the antenna of the RF emitting device;
positioning the headphone relative to an ear of the user such that the headphone is at least partially in-contact with the ear of the user; and
emitting the RF energy from the antenna of the RF emitting device while the headphone is at least partially in-contact with the ear of the user.

4. The method of claim 3, wherein configuring the headphone of the pair of headphones with the antenna of the RF emitting device comprises positioning the antenna underneath a cushion of the headphone.

5. The method of claim 3, wherein configuring the headphone of the pair of headphones with the antenna of the RF emitting device comprises positioning the antenna within a housing of the headphone.

6. The method of claim 3, wherein the emitting comprises emitting one or more RF signals having a frequency at 2.45 Gigahertz (GHz), or within a given percentage of the frequency.

7. The method of claim 1, further comprising:
determining a given amount of voltage stored at the storage element;
comparing the given amount of voltage stored at the storage element to a voltage threshold; and
seizing the converting of the RF energy to the electrical energy based on a result of the comparison.

8. The method of claim 5, further comprising coupling the antenna of the RF emitting device to an RF source via RF cables to receive the one or more RF signals.

9. A system comprising:
a hearing device comprising:
an antenna configured to receive radio-frequency (RF) energy while the hearing device is being worn by a user;
an RF harvester configured to convert the RF energy to electrical energy; and
a power storage element configured to receive and store the electrical energy.

10. The system of claim 9, further comprising:
an RF emitting device comprising:
an RF source configured to generate the RF energy; and
an antenna configured to emit the RF energy.

11. The system of claim 10, wherein the antenna comprises one of a helical antenna, monopole antenna, dipole antenna, loop antenna, patch antenna, and an inverted-F antenna.

12. The system of claim 10, wherein the antenna of the hearing device and the antenna of the RF emitting device are different antenna types.

13. The system of claim 10, wherein the antenna of the hearing device and the antenna of the RF emitting device are helical antennas.

14. The system of claim 10, wherein the power storage element comprises one or more capacitors.

15. The system of claim 10, wherein the power storage element comprises a battery.

16. The system of claim 11, wherein the RF source is configured to generate the RF energy having a frequency at 2.45 Gigahertz (GFH), or within a given percentage of the frequency.

17. The system of claim 11, wherein the antenna of the RF emitting device is configured relative to a headphone of a pair of headphones, and the headphone is positioned relative to an ear of the user such that the headphone is at least partially in-contact with the ear of the user, wherein the antenna of the RF emitting device is configured to emit the RF energy while the headphone is at least partially in-contact with the ear of the user.

18. A method for wirelessly charging a hearing device comprising:
configuring an antenna of a radio-frequency (RF) emitting device to emit RF energy;
receiving at an antenna of the hearing device the RF energy while the hearing device is being worn by a user;
converting the RF energy to electrical energy; and
providing the electrical energy to a storage element of the hearing device corresponding to storing charge at the storage element of the hearing device.

19. The method of claim 18, further comprising:
configuring a headphone of a pair of headphones with the antenna of the RF emitting device;
positioning the headphone relative to an ear of the user such that the headphone is at least partially in-contact with the ear of the user; and
emitting the RF energy from the antenna of the RF emitting device while the headphone is at least partially in-contact with the ear of the user.

20. The method of claim 19,
wherein the antenna of the hearing device and the antenna of the RF emitting device are helical antennas; and
wherein the power storage element comprises one of a battery and one or more capacitors.
